(19) United States
(12) Patent Application Publication
(10) Pub. No.: US 2017/0310067 A1
(43) Pub. Date: Oct. 26, 2017

(54) INSERT MOLDED PRODUCT AND INSERT MOLDED PRODUCT PRODUCTION METHOD

(71) Applicant: Mitsuba Corporation, Gunma (JP)

(72) Inventor: Jumpei Omukai, Kiryu-shi (JP)

(21) Appl. No.: 15/520,655

(22) PCT Filed: Nov. 4, 2015
(86) PCT No.: PCT/JP2015/081059

§ 371 Date: Apr. 20, 2017

(30) Foreign Application Priority Data
Nov. 11, 2014 (JP) 2014-228807

(51) Int. Cl. H01R 43/24; H01R 43/18; B29C 45/14; H01R 43/26

(52) U.S. Cl. CPC H01R 43/24; H01R 43/26; B29C 45/14008; B29C 45/14655; H01R 43/18

(57) ABSTRACT

A plurality of terminals are connected via a connection part in advance, the connection part is a cut part formed by cutting, after the plurality of terminals are set in a mold, the connection part using a slide core of the mold, and in this state, the plurality of terminals are buried in a connector housing.

### TECHNICAL FIELD

The present invention relates to an insert molded product and an insert molded product production method.

Priority is claimed on Japanese Patent Application No. 2014-228807, filed on Nov. 11, 2014, the contents of which are incorporated herein by reference.

### BACKGROUND

In the related art, techniques have been known in which when arranging a plurality of terminals on a mold in advance and injecting a resin into a cavity formed in the mold to mold a resin case, the terminals are molded to be inserted by insert molding in the resin case to thereby simplify a holding structure of each terminal in the resin case.

Although the above techniques can simplify the holding structure of each terminal in the resin case, the work of arranging the plurality of terminals on the mold in advance is bothersome. Therefore, a variety of techniques are disclosed in which the plurality of terminals are connected via a connection part (carrier) and thereby are integrated to be arranged in the mold, and the connection part is cut at the time of insert molding to ensure insulation of each terminal.

For example, a technique below is known. First, a plurality of terminals connected to each other via a connection part is arranged on a mold for primary molding, and primary molding is performed such that the connection part is exposed. Next, the primary molded product is arranged on a lower mold of a split mold, and the connection part is cut by using a cutter from the above. Then, after cutting the connection part, the primary molded product is arranged on a mold for secondary molding, and insert molding is performed such that the primary molded product is molded to be inserted in the secondary molded product. Thereby, it becomes unnecessary to arrange the plurality of terminals on the mold one by one, and therefore, it is possible to simplify the work of insert molding of the terminal (for example, refer to Patent Document 1).

### RELATED ART DOCUMENTS

### Patent Documents

[Patent Document 1] Japanese Patent Application, First Publication No. 2003-36951

### SUMMARY OF INVENTION

### Problem to be Solved by the Invention

The above insert molding of the related art, the connection part is cut by using the cutter from the above of the plurality of terminals arranged on the base mold, and therefore, a cut piece of the connection part is curved along the plate thickness direction of the terminal. Therefore, the entire terminal becomes thick in the plate thickness direction, and the degree of freedom of arrangement of the terminal may be limited.

Further, when this structure is adopted for a connector part in which the terminal is molded to be inserted by insert molding, the thickness of the connector part is increased, and therefore, it may be difficult to reduce the size of the insert molded product.

The present invention provides an insert molded product and an insert molded product production method capable of preventing the increase of a thickness in a plate thickness direction of an electrically conductive member such as a terminal and capable of enhancing the degree of freedom of arrangement of the electrically conductive member while simplifying the man-hour of molding.

### Means for Solving the Problem

According to a first aspect of the present invention, an insert molded product is a product formed by insert molding in which at least part of each of a plurality of electrically conductive members is buried in a resin molded body, wherein the plurality of electrically conductive members are connected via a connection part in advance, and wherein the connection part is a cut part formed by cutting, after the plurality of electrically conductive members are set in a mold, the connection part using a slide core of the mold, and in this state, the plurality of electrically conductive members are buried in the resin molded body.

As described above, the connection part is cut by using the slide core of the mold, and therefore, it is possible to enhance the degree of freedom of cut direction of the connection part while simplifying the cut work of the connection part. That is, it is possible to enhance the degree of freedom of direction in which the cut part is bent. Therefore, it is possible to prevent the increase of the thickness in the plate thickness direction of the electrically conductive member in the insert molded product, and it is possible to enhance the degree of freedom of arrangement of the electrically conductive member.

According to a second aspect of the present invention, in the insert molded product according to the first aspect of the present invention, each of the plurality of electrically conductive members has a plate shape, and the cut part is cut in a form in which the connection part is bent along a direction that is crossed with a plate thickness direction of the electrically conductive member.

According to the configuration described above, it is possible to reliably prevent the increase of the thickness in the plate thickness direction of the connection part. Therefore, it is possible to reduce the size of the insert molded product.

According to a third aspect of the present invention, in the insert molded product according to the first aspect or the second aspect of the present invention, the plurality of electrically conductive members are terminals of a connector part that is electrically connected to an external connector, and the cut part is cut in a form in which the cut part is bent along a longitudinal direction of the terminal.

According to the configuration described above, it is possible to prevent the increase of the thickness in the plate thickness direction of the terminal, and it is possible to reduce the size of the insert molded product that includes the connector part and to enhance the layout quality of the terminal.

According to a fourth aspect of the present invention, in the insert molded product according to any one of the first aspect to the third aspect of the present invention, a portion of the cut part is exposed from the resin molded body.

When a resin is cast into a cavity in the mold in a state where the connection part remains being cut (the cut part is formed) by using the slide core, the cut part is exposed from the resin molded body. In this way, a portion of the cut part being exposed from the resin molded body means that the resin is cast into the mold while maintaining the cut state of the connection part. According to the configuration described above, it is possible to reliably prevent short circuit of the electrically conductive member at the time of resin molding.

Further, according to the formation such that a portion of the cut part is exposed from the resin molded body, it is possible to prevent part of the resin molded body from being thickened, and it is possible to prevent shrinkage of the resin molded body.

According to a fifth aspect of the present invention, in the insert molded product according to any one of the first aspect to the fourth aspect of the present invention, the plurality of electrically conductive members include a reception part used for causing the mold to receive a load that occurs when cutting the connection part using the slide core.

According to the configuration described above, it is possible to reliably cut the connection part by the slide core. Further, it is possible to prevent deformation of the electrically conductive member due to stress at the time of cutting the connection part.

According to a sixth aspect of the present invention, in the insert molded product according to any one of the first aspect to the fifth aspect of the present invention, a notch part for being easily cut is formed on the connection part.

According to the configuration described above, it is possible to easily cut the connection part, and therefore, it is possible to relax stress that is applied on the electrically conductive member when cutting the connection part.

According to a seventh aspect of the present invention, in the insert molded product according to any one of the first aspect to the sixth aspect of the present invention, the cut parts formed from the one connection part have a different length of the cut connection part.

The different length of the cut connection part means that the shape of a cutting blade or the like that cuts the connection part is a single-edged blade shape. According to such a configuration, the separation distance between the cut connection parts can be further easily ensured compared to a case of a double-edged blade shape. In other words, a creepage distance between the cut connection parts can be easily ensured.

That is, in the case of the single-edged blade shape, a creepage distance between the cut connection parts can be easily ensured without inserting deeply the cutting blade or the like in the connection part. This is because the movement distance of the cut end becomes longer as the length of the cut connection part is longer even at the same bent angle. Therefore, according to the length of the cut connection part being different, it is possible to reliably ensure the insulation quality of the electrically conductive member.

According to an eighth aspect of the present invention, an insert molded product production method is a production method of an insert molded product in which at least part of each of a plurality of electrically conductive members is buried in a resin molded body, the production method includes: a setting step of setting, in a mold, the plurality of electrically conductive members connected via a connection part in advance; a cutting step of, after the setting step, cutting the connection part using a slide core of the mold to make the connection part be a cut part; and a molded body formation step of, after the cutting step, casting a resin in the mold and forming the resin molded body.

According to the production method described above, it is possible to prevent the increase of the thickness in the plate thickness direction of the electrically conductive member in the insert molded product, and it is possible to enhance the degree of freedom of arrangement of the electrically conductive member.

According to a ninth aspect of the present invention, in the insert molded product production method according to an eighth aspect of the present invention, the plurality of electrically conductive members are terminals electrically connected to an external connector, a connector housing capable of being fit to the external connector is provided at a position that corresponds to the terminal of the resin molded body, the slide core is a core by which the connector housing is formed, and a cutting blade is provided on the core to cut the connection part using the cutting blade.

According to the production method described above, it is possible to constitute, by one component, a function of the core that forms the connector housing and a function of cutting the connection part without separately providing the cutting blade as another slide core.

### Advantage of the Invention

According to the insert molded product described above, the connection part is cut by using the slide core of the mold, and therefore, it is possible to enhance the degree of freedom of cut direction of the connection part while simplifying the cut work of the connection part. That is, it is possible to enhance the degree of freedom of direction in which the cut part is bent. Therefore, it is possible to prevent the increase of the thickness in the plate thickness direction of the electrically conductive member in the insert molded product, and it is possible to enhance the degree of freedom of arrangement of the electrically conductive member.

### BRIEF DESCRIPTION OF THE DRAWINGS

FIG. 1 is a perspective view of an electrically driven pump according to an embodiment of the present invention.

FIG. 2 is an A arrow view of FIG. 1.

FIG. 3 is a schematic configuration view of a mold according to the embodiment of the present invention.

FIG. 4 is a B arrow view of FIG. 3.

FIG. 5 is a perspective view of a plurality of initial terminals according to an embodiment of the present invention.

FIG. 6 is a schematic configuration view showing a slide core of the mold in a closed state according to the embodiment of the present invention.

FIG. 7 is a C arrow view of FIG. 6.

FIG. 8 is a perspective view showing the slide core of the mold in a closed state according to the embodiment of the present invention.

FIG. 9 is a schematic configuration view showing a lower mold and an upper mold in a closed state according to the embodiment of the present invention.

FIG. 10 is a perspective view of a connector part according to the embodiment of the present invention.

FIG. 11 is a view showing a state in which a connection part is cut by using a cutting blade according to the embodiment of the present invention.

FIG. 12 is a view showing a state in which the connection part is cut by using a cutting blade having another form.

### DESCRIPTION OF THE EMBODIMENTS

Next, an embodiment of the present invention is described with reference to the drawings.

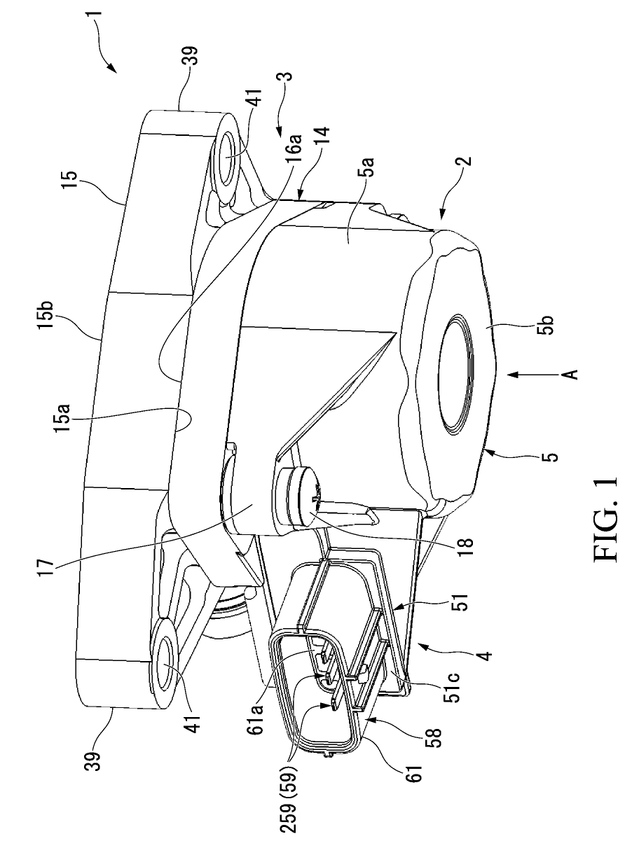

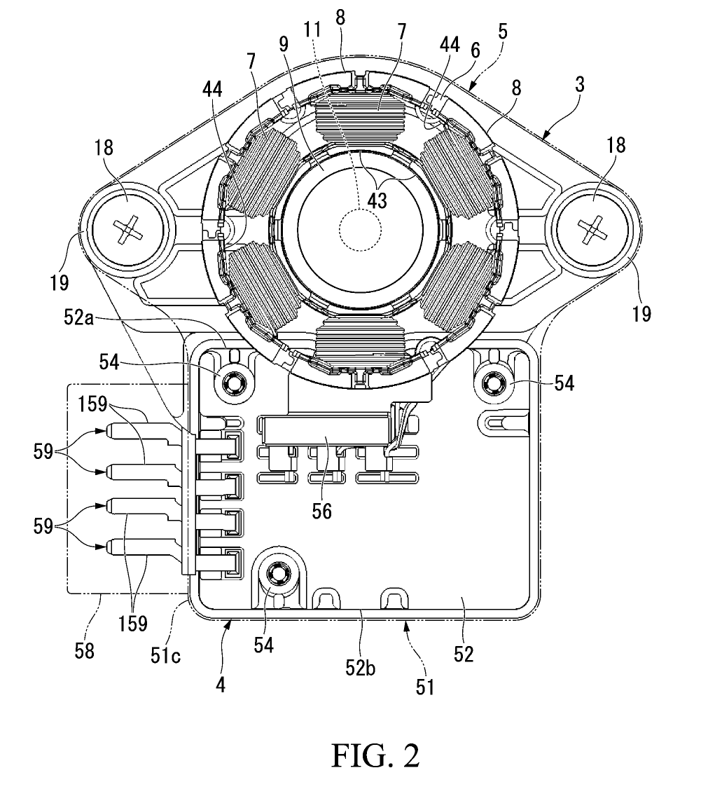

FIG. 1 is a perspective view of an electrically driven pump 1 using a motor case 5 as an insert molded product. FIG. 2 is an A arrow view of FIG. 1 and is a transmission view showing a state in which the motor case 5 is transmitted.

As shown in FIG. 1 and FIG. 2, the electrically driven pump 1 is used for supplying oil, for example, in order to drive a transmission (not shown) provided on an automobile (not shown), to the transmission. The electrically driven pump 1 is formed by integrating a motor part 2, a pump part 3 that is connected to the motor part 2 and that is arranged on the same axis as the motor part 2, and a control unit 4 that is arranged between the motor part 2 and the pump part 3 and on an outer circumferential surface side of the motor part 2 and the pump part 3.

In the following description, the axis direction of a rotation shaft 11 described below of the motor part 2 is simply referred to as an axial direction, the direction that is orthogonal to the axial direction and is a radial direction of the rotation shaft 11 is simply referred to as a radial direction, and the circumference direction of the rotation shaft 11 is simply referred to as a circumferential direction.

### (Motor Part)

The motor part 2 has the motor case 5 having a substantially cylindrical shape having a bottom formed of a resin. A stator 6 is molded to be inserted by insert molding in a circumferential wall 5a of the motor case 5. That is, the circumferential wall 5a of the motor case 5 is formed to be thick compared to a bottom wall 5b such that the stator 6 can be buried.

As shown in detail in FIG. 2, the stator 6 is formed in a substantially cylindrical shape by laminating electromagnetic steel sheets or according to compression molding of a soft magnetic powder. The stator 6 is formed in a shape in which a plurality of (six in this embodiment) teeth 43 are provided on an inner circumferential surface side to protrude. A slit 44 having an ant groove shape is formed between the teeth 43 that are adjacent in the circumferential direction, and a plurality of (for three phases which are a U phase, a V phase, and a W phase in this embodiment) winding wires 7 are provided to be wound around on each of the teeth 43 through the slits 44. Further, an insulator 8 is interposed between the teeth 43 and the winding wire 7, and the insulation quality between the teeth 43 (stator 6) and the winding wire 7 is ensured.

The stator 6 having the configuration described above is molded to be inserted by insert molding in the circumferential wall 5a of the motor case 5 in a state where only a front end (inner circumferential surface of the stator 6) of the teeth 43 is exposed to an inner surface side of the motor case 5.

A can 9 having a cylindrical shape having a bottom is attached to a pump main body 14 described below on an inner side in the radial direction of the stator 6. The can 9 is formed in a cylindrical shape having a bottom, for example, by applying a deep drawing process on a plate material such as a non-magnetic body (for example, stainless steel) and is formed such that the inside can be filled with oil. That is, the electrically driven pump 1 has a can structure that prevents oil from entering the inside of the stator 6.

The rotation shaft 11 of a rotor (not shown) is provided, rotatably with respect to the stator 6, on the pump main body 14 described below inside the can 9 on the inner side in the radial direction of the stator 6. The rotor includes a plurality of permanent magnets (not shown) at a position that is opposed in the radial direction to a front end of the teeth 43. The pump part 3 is connected to the rotor.

A bolt seat 17 is formed on an outer circumferential part of the motor case 5 to extend radially outward. The bolt seat 17 is used for fixing the motor part 2 and the pump part 3 and is formed such that a bolt 18 can be inserted through the bolt seat 17.

### (Pump Part)

The pump part 3 includes the pump main body 14 which is arranged on the motor part 2 and in which a pump room (not shown) described below used for suctioning and discharging oil is formed and a bracket 15 arranged on an opposite side of the motor part 2 of the pump main body 14. The pump main body 14 houses a trochoidal pump (not shown).

The bracket 15 is formed, for example, by aluminum die casting and is formed in a flat plate shape so as to overlap with an end surface 16a of a pump case 16. An end surface 15b on an opposite side of an end surface 15a on the pump case 16 side is attached to the transmission (not shown), and an oil path is connected to an oil path on the transmission side. A bolt seat 39 used for fixing the electrically driven pump 1 to an attachment surface of the transmission is formed on an outer circumferential part of the bracket 15 to extend. A through-hole 41 through which a bolt (not shown) can be inserted is formed on the bolt seat 39.

### (Control Unit)

The control unit 4 controls and drives the motor part 2. The control unit 4 has a control unit case 51 molded integrally with the motor case 5 and which is made of resin on an outer circumferential surface on the pump unit 3 side of the motor case 5. The control unit case 51 is formed in a box shape so as to open at the pump part 3 side and is formed to have a substantially rectangular shape in plan view (hereinafter, simply referred to as axial direction plan view) seen from an axial direction of the electrically driven pump 1. The control unit case 51 houses a control board 52 used for controlling and driving the motor part 2.

The control board 52 is formed in a substantially rectangular shape in axial direction plan view so as to correspond to the shape of the motor case 5. The control board 52 is fixed by fastening to the control unit case 51 via three tapping screws 54. A plurality of switching elements 56 such as a FET (Field Effect Transistor), an IC (Integrated Circuit) element (not shown), a capacitor (not shown), a resistance (not shown), a diode (not shown), and the like are mounted on the control board 52. The winding wire 7 of the motor part 2 is electrically connected to the control board 52, and one end of a plurality of terminals 59 in use for power and sensor applications is connected to the control board 52. The plurality of terminals 59 are formed in a substantially L shape, and the other end of the plurality of terminals 59 protrudes outward along a direction orthogonal to the axial direction.

### (Connector Part)

A connector part 58 is molded integrally with one side surface 51c in the longitudinal direction of the control unit case 51, that is, at a position that corresponds to the other end of the plurality of terminals 59. The connector part 58 has a connector housing 61 having a substantially square tube shape that opens at the outer side, and the other end of the plurality of terminals 59 protrudes into the connector housing 61. That is, the other end of the terminal 59 forms the connector part 58.

By fitting an external connector (not shown) to the connector housing 61, it is possible to supply electric power of an external power source to the control unit via the plurality of terminals 59, and it is possible to perform signal input/output with the external control apparatus. Further, it is possible to supply electric power of the external power source to the control board 52, and it is possible to perform signal input/output between the external control apparatus and the control board 52. The plurality of terminals 59 are molded to be inserted by insert molding in the control unit case 51.

### (Production Method of Connector Part)

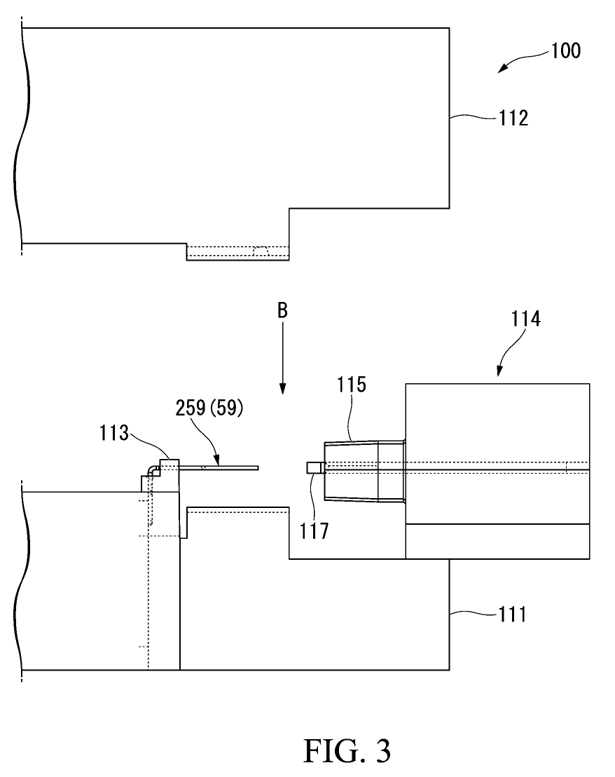

Next, a production method of the connector part 58 is described with reference to FIG. 3 to FIG. 9.

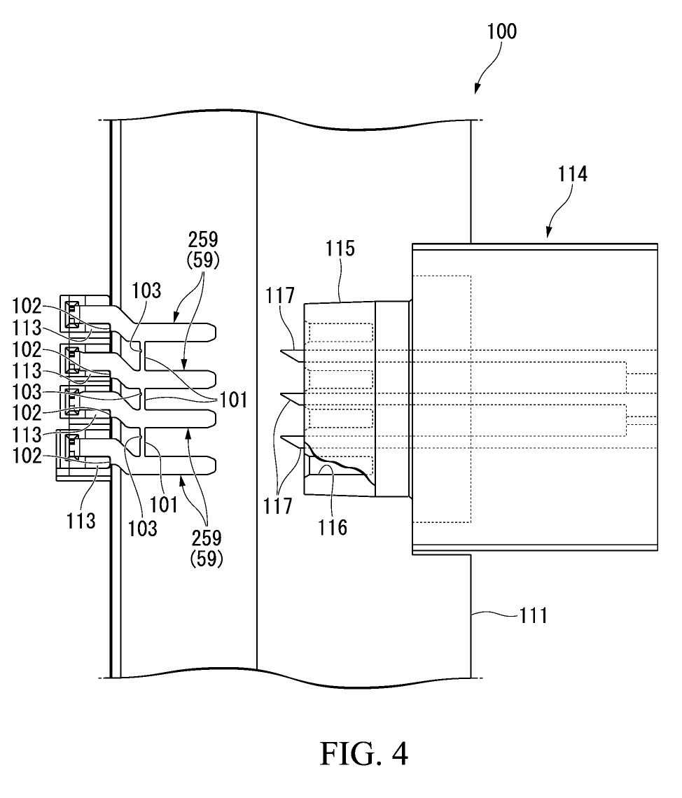

FIG. 3 is a schematic configuration view of a mold 100 used when molding the connector part 58. FIG. 4 is a B arrow view of FIG. 3. The connector part 58 is molded integrally with the motor case 5, and the mold 100 is used to mold the connector part 58 and the motor case 5. However, in the following description, only a part at which the connector part 58 is molded is described in detail, and the description with respect to molding of the motor case 5 and insert molding of the stator 6 is omitted.

As shown in FIG. 3 and FIG. 4, the mold 100 is a so-called split mold formed of a lower mold 111 and an upper mold 112. First, the plurality of terminals 59 are arranged at a position, at which the connector housing 61 is to be formed, of the lower mold 111 (setting step).

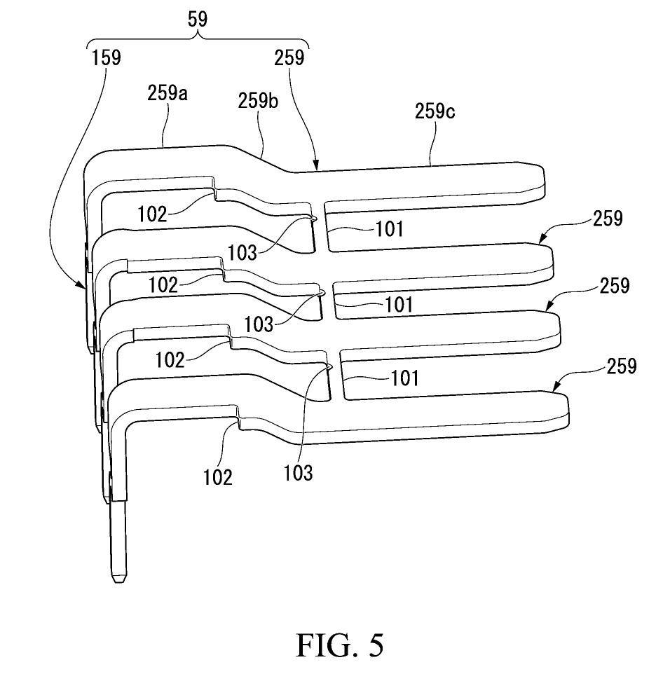

The plurality of terminals 59 (hereinafter, referred to as a plurality of initial terminals 59) arranged on the lower mold 111 is described with reference to FIG. 5.

FIG. 5 is a perspective view of the plurality of initial terminals 59.

As shown in FIG. 5, the plurality of initial terminals 59 are integrally connected via a connection part 101.

The terminal 59 has one end that is formed to be a control terminal 159 which is connected to the control board 52 and the other end that is formed to be a connector terminal 259 which is arranged inside the connector housing 61. The terminal 59 is arranged on the lower mold 111 such that the control terminal 159 is directed along a demolded direction (vertical direction) of the mold 100 and such that the connector terminal 259 is directed along a horizontal direction that is orthogonal to the demolded direction. The terminal 59 is arranged such that the plate thickness direction of the connector terminal 259 is directed along the demolded direction of the mold 100.

The connector terminal 259 is formed to be bent in a crank shape in plan view from the plate thickness direction. More specifically, the connector terminal 259 is formed of a base end part 259a that is bent at a substantially right angle to extend from a base end of the control terminal 159, a bent part 259b that is bent to extend along the width direction of the connector terminal 259 from a front end of the base end part 259a, and a plug part 259c that is bent to extend from the front end of the bent part 259b along the same direction as the extension direction of the base end part 259a, which are formed in series.

Part of the base end part 259a and the bent part 259b are buried in a bottom wall part 61a of the connector housing 61. On the other hand, the plug part 259c protrudes into the connector housing 61 and is electrically connected to the external connector (not shown).

A reception part 102 that protrudes along the width direction of the terminal is integrally molded on the base end part 259a side of the bent part 259b. The reception part 102 is capable of being engaged with a holding bar 113 described below that is formed on the lower mold 111. The connection part 101 is provided on the bent part 259b side of the plug part 259c.

The connection part 101 is formed to extend along the width direction at a position close to the bent part 259b of the plug part 259c of the connector terminal 259 so as to bridge a gap between the adjacent connector terminals 259. A notch part 103 is formed on a lateral side, on the control terminal 159 side, of the connection part 101. The notch part 103 is formed in advance such that the connection part 101 can be easily cut. The notch part 103 is arranged to be displaced close to one connector terminal 259 from the center in the longitudinal direction of the connection part 101. More specifically, in FIG. 5, the notch part 103 is formed close to an upper connector terminal 259 of adjacent two connector terminals 259.

With reference back to FIG. 3 and FIG. 4, the holding bar 113 is provided on the lower mold 111 to protrude toward the upper mold 112 at a position where the plurality of initial terminals 59 are to be arranged. More specifically, the holding bar 113 is provided to protrude at a position corresponding to the reception part 102 of each terminal 59 and is provided to protrude so as to sandwich the base end part 259a of each terminal 59 in the width direction. Therefore, when arranging the plurality of initial terminals 59 on the lower mold 111, the reception part 102 of each terminal 59 is engaged with the holding bar 113 of the lower mold 111.

A slide core 114 used for forming the connector housing 61 is provided on the lower mold 111. The slide core 114 is formed movably in a sliding manner manually along the direction that is orthogonal to the demolded direction with respect to the lower mold 111. A core 115 used for forming an inner circumferential surface of the connector housing 61 is provided on the slide core 114. An insertion hole 116 in which a front end part of one of the connector terminals 259 can be inserted is formed on the core 115 at a position that corresponds to each of the connector terminals 259.

A cutting blade 117 is provided to protrude toward the connection part 101 of the plurality of initial terminals 59 on the core 115 between the insertion holes 116. The cutting blade 117 is used for cutting the connection part 101 and is formed in a single-edged blade shape. A front end of the cutting blade 117 is arranged at a position that corresponds to a surface on an opposite side of the notch part 103 of the connection part 101.

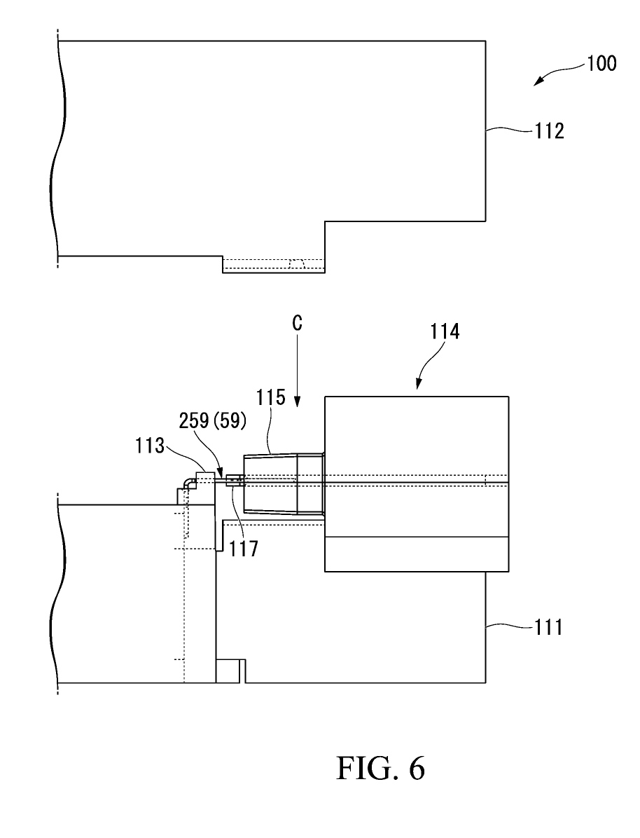

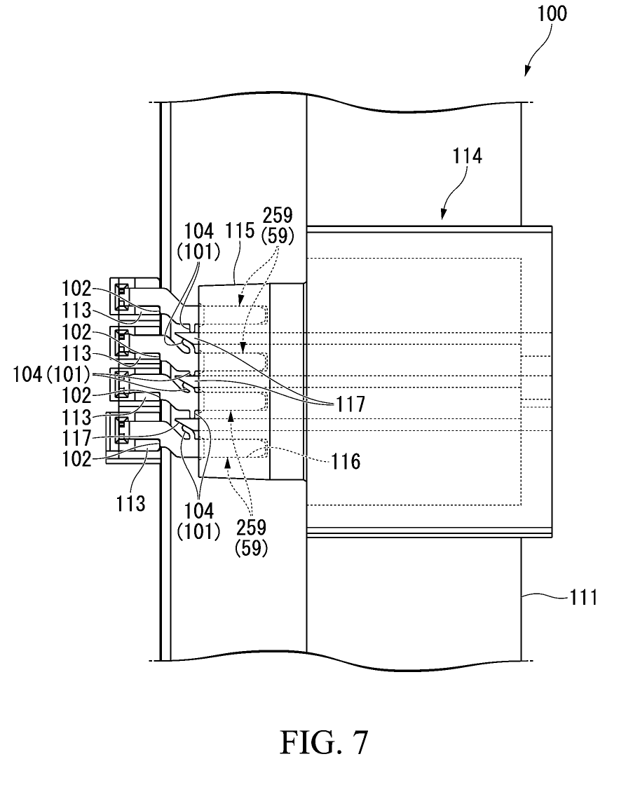

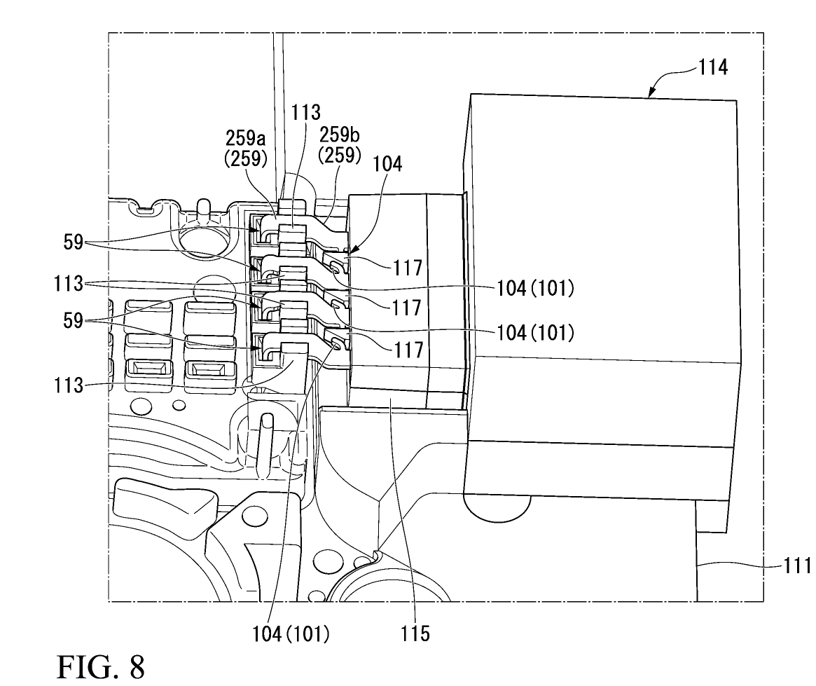

FIG. 6 is a schematic configuration view showing the slide core 114 of the mold 100 in a closed state. FIG. 6 corresponds to FIG. 3 described above. FIG. 7 is a C arrow view of FIG. 6. FIG. 7 corresponds to FIG. 4 described above. FIG. 8 is a perspective view showing the slide core 114 of the mold 100 in a closed state.

As shown in FIG. 6 to FIG. 8, after the plurality of initial terminals 59 are arranged on the lower mold 111, the slide core 114 is manually closed and is fixed. At this time, the cutting blade 117 is butted to the connection part 101, and the connection part 101 is cut by the cutting blade 117 (cutting step).

The notch part 103 is formed on the connection part 101. Further, the front end of the cutting blade 117 is butted to the position that corresponds to the surface on the opposite side of the notch part 103, and therefore, the connection part 101 is easily cut.

The reception part 102 is formed on each connector terminal 259, and the holding bar 113 of the lower mold 111 is provided to protrude on an opposite side of the slide core 114 in the reception part 102. That is, the reception part 102 and the holding bar 113 are engaged with each other. Therefore, the holding bar 113 receives stress when the cutting blade 117 is butted to the connection part 101 via the reception part 102. Accordingly, it is possible to prevent each connector terminal 259 from being deformed by the stress when the cutting blade 117 is butted to the connection part 101.

In this way, the connection part 101 that is cut by the cutting blade 117 becomes a cut part 104 that is formed by the connection part 101 being divided.

The cut parts 104 formed from one connection part 101 have a different length of the cut connection part 101. That is, since the connection part 101 is divided from a front end (notch part 103) of the cutting blade 117 having a single-edged blade shape, in FIG. 7 and FIG. 8, the length of the cut connection part 101 that remains on the upper side of the adjacent connector terminals 259 is shorter, and the length of the cut connection part 101 that remains on the lower side is longer.

The cutting blade 117 is slided from a front end of the connector terminal 259 along the longitudinal direction of the connector terminal 259 to cut the connection part 101. Therefore, as shown in detail in FIG. 8, the cut connection part 101 (cut part 104) is bent along the longitudinal direction of the connector terminal 259. In other words, the cut part 104 is bent along a direction that is orthogonal to a plate thickness direction of the terminal 59.

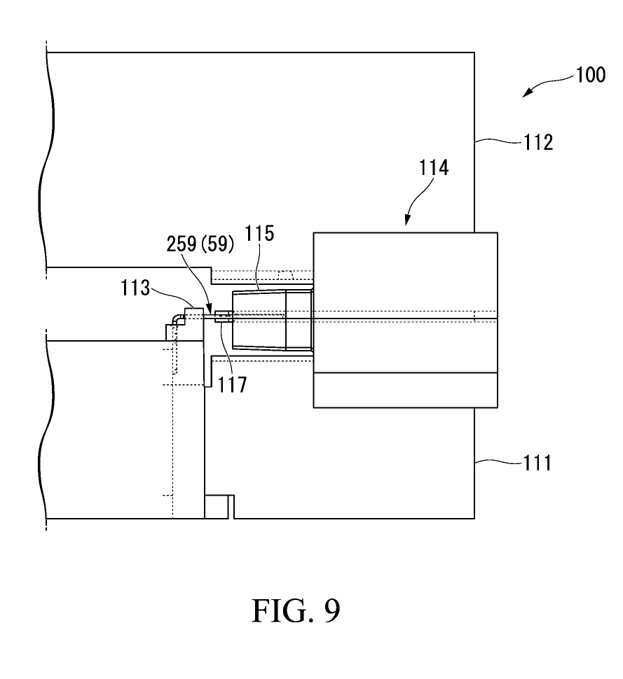

FIG. 9 is a schematic configuration view showing the lower mold 111 and the upper mold 112 in a closed state. FIG. 9 corresponds to FIG. 3 and FIG. 6 described above.

As shown in FIG. 9, after sliding the slide core 114 of the lower mold 111 to cut the connection part 101 of the terminal 59 (after forming the cut part 104), the lower mold 111 and the upper mold 112 are closed while maintaining the state of the slide core 114. Then, a resin is cast into a cavity formed in the mold 100, and the motor case 5, the control unit case 51, and the connector part 58 (connector housing 61) are formed (molded body formation step).

At this time, stress due to injection of the resin is applied on each terminal 59. Then, this stress causes position displacement of each terminal 59. However, since the front end part of the connector terminal 259 of each terminal 59 is inserted in the insertion hole 116 of the slide core 114, the slide core 114 functions as a guide that prevents position displacement of each terminal 59, and position displacement of each terminal 59 is prevented.

Further, the resin is cast while maintaining a state in which the cutting blade 117 penetrates the connection part 101, and therefore, it is possible to reliably prevent the bent shape of the cut part 104 from being pushed back by the stress due to injection of the resin.

After the resin is cast in the mold 100 and the resin is cooled, the lower mold 111 and the upper mold 112 are demolded, and further, the slide core 114 of the lower mold 111 is demolded. Thereby, production of the motor case 5 and the connector part 58 is completed.

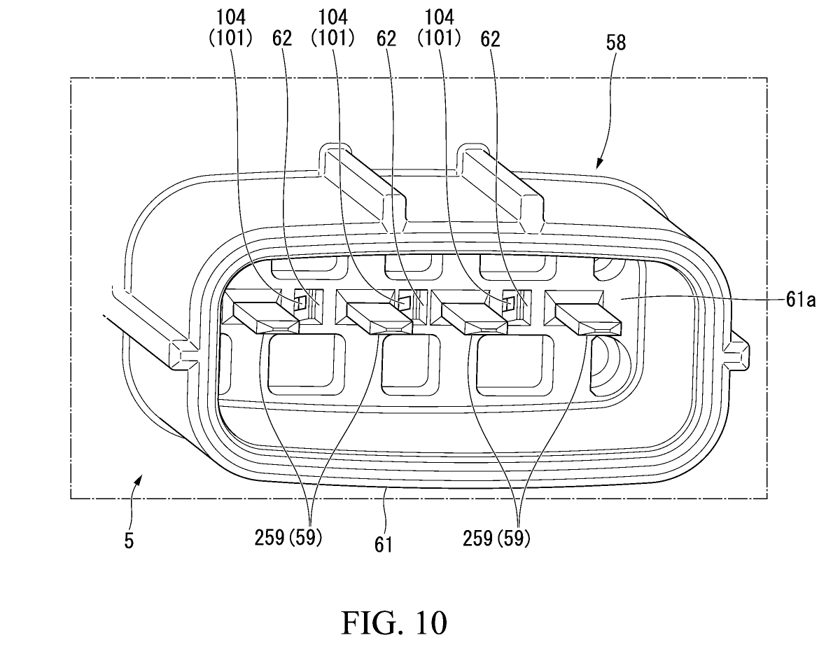

FIG. 10 is a perspective view of the connector part 58.

As shown in FIG. 10, a recess part 62 is formed on the completed bottom wall part 61a of the connector housing 61 between the connector terminals 259. This is because, when producing the connector part 58, the resin is cast in the mold 100 while maintaining a state where the slide core 114 is closed, that is, while maintaining a state where the front end of the cutting blade 117 in the slide core 114 penetrates the connection part 101. Accordingly, part (a front end) of the cut part 104 is exposed at a bottom part of the recess part 62.

The exposed part is positioned in a space that is sealed when the external connector is fit to the connector part 58.

Further, the recess part 62 is formed on the bottom wall part 61a of the connector housing 61, and therefore, the thickness of the bottom wall part 61a can be wholly thinned and uniformed. Therefore, it is possible to prevent shrinkage from occurring when cooling the connector housing 61.

The motor part 2, the pump part 3, the control board 52, and the like are attached to the motor case 5 formed in this way to complete the electrically driven pump 1.

In the electrically driven pump 1, a current is supplied to the control board 52 via the connector part 58, and further, the supplied current is supplied selectively to the plurality of winding wires 7 that are wound around the stator 6. Thereby, a desired magnetic flux is formed on the stator 6, and a magnetic attraction force or repulsion force occurs between the magnetic flux and a permanent magnet 13 of a rotor 10. Then, the rotor 10 is rotated. The rotor 10 is rotated, and thereby, oil is suctioned and discharged via the bracket 15.

In this way, in the embodiment described above, when producing the connector part 58, after the plurality of terminals 59 that are connected in advance via the connection part 101 are arranged on the lower mold 111 and the connection part 101 is cut by using the slide core 114, resin molding is performed. In other words, the plurality of terminals 59 on which the cut part 104 is formed is buried in the connector housing 61. Therefore, it is possible to easily arrange the plurality of terminals 59 onto the lower mold 111, and it is possible to facilitate the cutting work of the connection part 101 of the plurality of initial terminals 59.

Further, the connection part 101 is cut by using the slide core 114, and therefore, the cut connection part 101 (cut part 104) is bent along the longitudinal direction of the connector terminal 259. In this way, the connection part 101 is not bent in the plate thickness direction of the connector terminal 259, and therefore, it is possible to prevent the increase of the thickness in the plate thickness direction of the connector terminal 259. Further, it is possible to enhance the degree of freedom of arrangement of the connector terminal 259, and it is also possible to reduce the size of the connector part 58 and further to reduce the size of the motor case 5.

Further, when producing the connector part 58, resin molding is performed while maintaining a state where the cutting blade 117 penetrates the connection part 101, and as a result, part (a front end) of the cut part 104 is exposed from the recess part 62 formed on the bottom wall part 61a of the connector housing 61. In this way, by performing resin molding while maintaining a state where the cutting blade 117 penetrates the connection part 101, it is also possible to prevent the bent shape of the cut part 104 from being pushed back by the stress due to injection of the resin.

Further, the recess part 62 is formed on the bottom wall part 61a of the connector housing 61, and therefore, the thickness of the bottom wall part 61a can be wholly thinned and uniformed. Therefore, it is possible to prevent shrinkage from occurring when cooling the connector housing 61.

Further, the insertion hole 116 through which the connector terminal 259 portion is inserted in the slide core 114 is provided, and thereby, it is possible to reliably prevent position displacement of each terminal 59 at the time of resin molding.

Further, the reception part 102 is formed on each connector terminal 259, and the holding bar 113 of the lower mold 111 is provided to protrude on an opposite side of the slide core 114 in the reception part 102. That is, the reception part 102 and the holding bar 113 are engaged with each other. Therefore, the holding bar 113 receives stress when the cutting blade 117 is butted to the connection part 101 via the reception part 102. Accordingly, it is possible to prevent each connector terminal 259 from being deformed by the stress when the cutting blade 117 is butted to the connection part 101.

Further, the notch part 103 is formed on the connection part 101, and therefore, cutting of the connection part 101 by the cutting blade 117 can be easily performed. Thereby, it is possible to relax stress when cutting the connection part 101, and it is possible to further reliably prevent deformation of each connector terminal 259.

Further, the cut parts 104 formed from one connection part 101 have a different length of the cut connection part 101. That is, since the connection part 101 is divided from a front end (notch part 103) of the cutting blade 117 having a single-edged blade shape, in FIG. 7 and FIG. 8, the length of the cut connection part 101 that remains on the upper side of the adjacent connector terminals 259 is shorter, and the length of the cut connection part 101 that remains on the lower side is longer. Therefore, it is possible to sufficiently ensure a creepage distance between the cut connection parts 101.

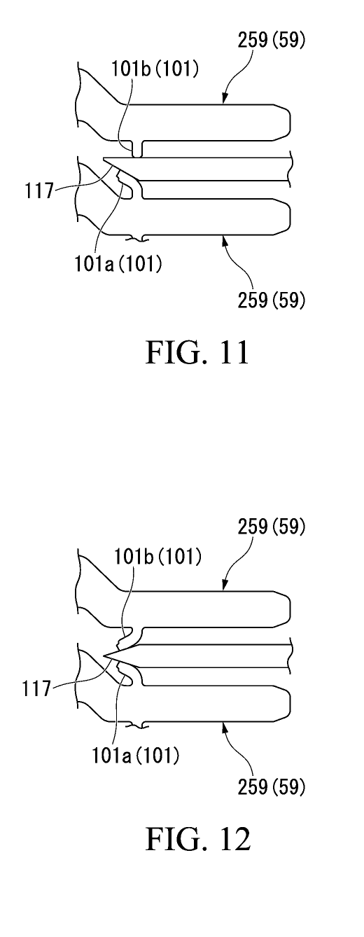

This is described more specifically with reference to FIG. 11 and FIG. 12.

FIG. 11 is a view showing a state in which the connection part 101 is cut by using the cutting blade 117 of the present embodiment. FIG. 12 is a view showing a state in which the connection part 101 is cut by using a cutting blade having another form.

First, a case is described in which the connection part 101 is cut by using the cutting blade 117 of the present embodiment.

As shown in FIG. 11, when the cutting blade 117 has a single-edged blade shape, a length of one connection part 101a (connection part on the lower side in FIG. 11) of the cut connection part 101 is longer than a length of the other connection part 101b (connection part on the upper side in FIG. 11). Therefore, when the two connection parts 101a, 101b are bent, a difference between a movement distance of the front end of the one connection part 101a and a movement distance of the front end of the other connection part 101b occurs, and a creepage distance between the front end of the one connection part 101a and the front end of the other connection part 101b becomes long.

On the other hand, as shown in FIG. 12, the cutting blade 117 may have a double-edged blade shape. In this case, a length of one connection part 101a (connection part on the lower side in FIG. 12) of the cut connection part 101 is substantially the same as a length of the other connection part 101b (connection part on the upper side in FIG. 12). Therefore, when the two connection parts 101a, 101b are bent, little difference between a movement distance of the front end of the one connection part 101a and a movement distance of the front end of the other connection part 101b occurs, and therefore, cutting while applying a uniform force on the connection part 101 can be performed. In the case of this embodiment, although a creepage distance between the front end of the one connection part 101a and the front end of the other connection part 101b becomes short, resin molding is applied on each terminal 59 in a subsequent process as described above, and therefore, insulation quality between the terminals 59 is ensured. When the cutting blade 117 has a double-edged blade shape, an extending surface distance between the two connection parts 101a, 101b may be increased by inserting the cutting blade 117 deeply.

In this way, in the embodiment described above, in the cut part 104 that is formed from one connection part 101, the two cut connection parts 101 have a different length, and therefore, the creepage distance between the cut connection parts 101 can be sufficiently ensured without setting the insertion position of the cutting blade 117 to a deep position beyond necessity.

Further, in the embodiment described above, the cutting blade 117 is provided on the core 115 of the slide core 114. Therefore, it is unnecessary to provide a slide core used for cutting the connection part 101 separately from the slide core 114 that molds the connector housing 61. Therefore, it is possible to reduce production costs when producing the connector part 58.

The present invention is not limited to the embodiment described above, and various changes can be added to the embodiment described above without departing from the scope of the present invention.

For example, the above embodiment is described using an example in which the slide core 114 is manually slided. However, the embodiment is not limited thereto. A configuration may be adopted in which the slide core 114 is slided in an interlocked manner with an operation of the lower mold 111 or the upper mold 112 by using an angular pin and the like. A configuration may be adopted in which the slide core 114 is slided by using a hydraulic cylinder and the like.

Further, the above embodiment is described using an example in which the resin is cast while maintaining a state in which the cutting blade 117 penetrates the connection part 101 when molding the connector housing 61. However, the embodiment is not limited thereto. A configuration may be adopted in which, after sliding the slide core 114 and cutting the connection part 101 using the cutting blade 117, the cutting blade 117 is moved to be evacuated, and then, a resin is cast. In this case, it is possible to prevent the cut part 104 from being exposed from the connector housing 61.

Further, the above embodiment is described using an example in which the slide core 114 is formed to be slidable along a direction that is orthogonal to the demolded direction with respect to the lower mold 111. However, the embodiment is not limited thereto. The slide core 114 may be formed to be slidable in a direction that is crossed with respect to the demolded direction.

Further, the above embodiment is described using an example in which the connection part 101 is formed to extend along the width direction at a position close to the bent part 259b of the plug part 259c of the connector terminal 259. However, the embodiment is not limited thereto. When the connector terminal 259 is formed to be bent in a crank shape in the plate thickness direction of the connector terminal 259, the connection part 101 of the adjacent connector terminals 259 may be set at an intermediate part of the crank shape. In this case, the two connection parts 101a, 101b cut by the cutting blade 117 of the slide core 114 can be positioned in a dead space of the crank shape of the connector terminal 259. In this way, the connection part 101 cut by the cutting blade 117 may be bent along a direction that is crossed with the plate thickness direction of the plug part 259c of the connector terminal 259, and it is possible to prevent the increase of the thickness in the plate thickness direction of the entire connector terminal 259 compared to at least a case in which the connection part 101 is bent in the demolded direction of the lower mold 111 and the upper mold 112.

Further, the above embodiment is described using an example in which, when burying the terminal 59 in the connector housing 61 (motor case 5), the terminals 59 are integrated via the connection part 101. However, the embodiment is not limited thereto. The connection part 101 described above or the configuration in which the connection part 101 is cut by using the slide core 114 can be adopted for a variety of electronic apparatuses formed by insert molding in which a plurality of electrically conductive members are molded to be inserted in a resin molded body.

### INDUSTRIAL APPLICABILITY

According to the insert molded product described above, the connection part is cut by using the slide core of the mold, and therefore, it is possible to enhance the degree of freedom of cut direction of the connection part while simplifying the cut work of the connection part. That is, it is possible to enhance the degree of freedom of direction in which the cut part is bent. Therefore, it is possible to prevent the increase of the thickness in the plate thickness direction of the electrically conductive member in the insert molded product, and it is possible to enhance the degree of freedom of arrangement of the electrically conductive member.

### DESCRIPTION OF THE REFERENCE SYMBOLS

5 motor case (resin molded body)
51 control unit case (resin molded body)
59 terminal (electrically conductive member)
61 connector housing (resin molded body)
100 mold
101 connection part
102 reception part
103 notch part
104 cut part
114 slide core
115 core
159 control terminal
259 connector terminal (terminal)

1. An insert molded product in which at least part of each of a plurality of electrically conductive members is buried in a resin molded body, wherein
the plurality of electrically conductive members are connected via a connection part in advance, and wherein
the connection part is a cut part formed by cutting, after the plurality of electrically conductive members are set in a mold, the connection part using a slide core of the mold, and in this state, the plurality of electrically conductive members are buried in the resin molded body.

2. The insert molded product according to claim 1, wherein each of the plurality of electrically conductive members has a plate shape, and the cut part is cut in a form in which the connection part is bent along a direction that is crossed with a plate thickness direction of the electrically conductive member.

3. The insert molded product according to claim 1, wherein the plurality of electrically conductive members are terminals of a connector part that is electrically connected to an external connector, and the cut part is cut in a form in which the cut part is bent along a longitudinal direction of the terminal.

4. The insert molded product according to claim 1, wherein a portion of the cut part is exposed from the resin molded body.

5. The insert molded product according to claim 1, wherein the plurality of electrically conductive members comprise a reception part used for causing the mold to receive a load that occurs when cutting the connection part using the slide core.

6. The insert molded product according to claim 1, wherein a notch part for being easily cut is formed on the connection part.

7. The insert molded product according to claim 1, wherein the cut parts formed from the one connection part have a different length of the cut connection part.

8. An insert molded product production method which is a production method of an insert molded product in which at least part of each of a plurality of electrically conductive members is buried in a resin molded body, the production method comprising:
a setting step of setting, in a mold, the plurality of electrically conductive members connected via a connection part in advance;
a cutting step of, after the setting step, cutting the connection part using a slide core of the mold to make the connection part be a cut part; and
a molded body formation step of, after the cutting step, casting a resin in the mold and forming the resin molded body.

9. The insert molded product production method according to claim 8, wherein
the plurality of electrically conductive members are terminals electrically connected to an external connector,
a connector housing capable of being fit to the external connector is provided at a position that corresponds to the terminal of the resin molded body,
the slide core is a core by which the connector housing is formed, and
a cutting blade is provided on the core to cut the connection part using the cutting blade.
